(19) United States
(12) Patent Application Publication
(10) Pub. No.: US 2008/0131076 A1
(43) Pub. Date: Jun. 5, 2008

(54) Content reproduction system, reproducers used in system, and content reproduction method

(75) Inventor: Hiroyuki Hashimoto, Suwa-gun (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/987,497

(22) Filed: Nov. 30, 2007

(30) Foreign Application Priority Data
Dec. 5, 2006 (JP) 2006-327773

(51) Int. Cl. H04N 5/91

(52) U.S. Cl. 386/66

(57) ABSTRACT

A content reproduction system uses a first reproducer and a second reproducer to respectively reproduce corresponding first content information and second content information, which are to be played back at a synchronized timing. A first delay amount specification module of the first reproducer obtains a first base delay amount corresponding to a reproduction timing of the first content information and a first additional delay amount set in a first delay processor of the first reproducer. The first delay amount specification module also receives a second base delay amount corresponding to a reproduction timing of the second content information and a second additional delay amount set in a second delay processor of the second reproducer, which are notified by a second delay amount specification module of the second reproducer. The first delay amount specification module updates the first additional delay amount and the second additional delay amount to make a second reproduction delay amount specified according to the second base delay amount and the second additional delay amount consistent with a first reproduction delay amount specified according to the first base delay amount and the first additional delay amount. The first delay amount specification module sets the updated first additional delay amount in the first delay processor, while giving an instruction to the second delay amount specification module to set the updated second additional delay amount in the second delay processor. This arrangement desirably reduces a potential time difference between a reproduction timing of the first content information by the first reproducer and a reproduction timing of the second content information by the second reproducer.

### BACKGROUND OF THE INVENTION

1. Field of the Invention

The present invention relates to a technique applied to a content reproduction system using a first reproducer and a second reproducer to respectively reproduce corresponding first content information and second content information, which are to be played back at a synchronized timing, for example, audio information and video information constituting one content. The technique of the present invention reduces a time difference between a reproduction timing of the first content information by the first reproducer and a reproduction timing of the second content information by the second reproducer.

2. Description of the Related Art

Video information and audio information, which are to be played back at a synchronized timing, may be reproduced by different reproducers. For example, the video information is reproduced by a projector as an image reproducer, while the audio information is reproduced by a speaker system including an amplifier and a speaker as a sound reproducer. In such applications, there is a time difference between a reproduction timing of the video information and a reproduction timing of the audio information. This time difference may be ascribed to a difference between a transmission timing of the video information from a content supplier as a supply source of the video information and the audio information to the image reproducer and a transmission timing of the audio information from the content supplier to the sound reproducer. The time difference may also be ascribed to a difference between transmission delays as time periods required for transmission of the video information and the audio information through respective transmission pathways between the content supplier and the image and sound reproducers, as well as a difference between reproduction delays as time periods required for reproduction of the video information and the audio information in the image and sound reproducers. In the description hereof, the terminology ‘synchronized’ means that the time difference between the reproduction timing of the video information and the reproduction timing of the audio information is sufficiently reduced or completely eliminated to cause the audience to feel no significant mismatch of the reproduced image with the reproduced sound. The terminology ‘unsynchronized’ means that the time difference of the reproduction timing is relatively large to cause the audience to feel a mismatch of the reproduced image with the reproduced sound. This time difference may be referred to as ‘synchronization error’.

As disclosed in Japanese Patent Laid-Open No. 2004-88442 and No. 2004-104658, one proposed technique delays the reproduction timing of the audio information to adjust the synchronization error caused by the difference between the transmission delays arising in the transmission pathways (hereafter may be referred to as ‘transmission delay difference’). As disclosed in Japanese Patent Laid-Open No. 2004-282667 and No. 2004-320424, another proposed technique delays the transmission timing of the audio information relative to the transmission timing of the video information in the content supplier to reduce the transmission delay difference and thereby adjust the synchronization error.

The reduction of the transmission delay difference may, however, fail to adjust the synchronization error, since the synchronization error may be caused by the difference between the transmission timings of the content supplier (hereafter may be referred to as ‘transmission timing difference’). There may also be a synchronization error caused by different transmission pathways of the video information and the audio information as in satellite relaying broadcast. The delayed transmission timing of the audio information thus not always solves the problem of the synchronization error.

The synchronization error may also be caused by the difference between the reproduction delay in the image reproducer and the reproduction delay in the sound reproducer (hereafter may be referred to as ‘reproduction delay difference’). There has, however, been no standard procedure of reducing the reproduction delay difference.

For adjustment of the synchronization error caused by the transmission delay difference in the content supplier, the content supplier is required to have an additional function of comparing and controlling a delay between the content supplier and the image reproducer and a delay between the content supplier and the sound reproducer. The content supplier generally has no mechanism of adjusting the unsynchronized reproduction timing of the audio information with the reproduction timing of the video information.

The above description regards the video information and the audio information that are to be played back at the synchronized timing. The similar problem, however, arises in reproduction of any first content information and second content information, which are to be played back at a synchronized timing, respectively by a first reproducer and a second reproducer, for example, two different pieces of video information to be played back at a synchronized timing or two different pieces of audio information to be played back at a synchronized timing.

In reproduction of first content information and second content information, which are to be played back at a synchronized timing, respectively by a first reproducer and a second reproducer, for example, audio information and video information constituting a first content, there would be a demand for a technique of reducing a potential time difference between a reproduction timing of the first content information by the first reproducer and a reproduction timing of the second content information by the second reproducer.

### SUMMARY OF THE INVENTION

In order to achieve at least part of the above demands, one aspect of the invention pertains to a content reproduction system that uses a first reproducer and a second reproducer to respectively reproduce corresponding first content information and second content information, which are to be played back at a synchronized timing. The first reproducer has: a first delay processor that delays a reproduction timing of the first content information supplied to the first reproducer; and a first delay amount specification module that specifies a delay amount for the first delay processor and sets the specified delay amount in the first delay processor. The second reproducer has: a second delay processor that delays a reproduction timing of the second content information supplied to the second reproducer; and a second delay amount specification module that specifies a delay amount for the second delay processor and sets the specified delay amount in the second delay processor.

A first reproduction delay amount representing a time period required for actual start of reproduction of the first content information supplied to the first reproducer is specified according to a first base delay amount corresponding to a reproduction condition of the first content information and a first additional delay amount set in the first delay processor. A second reproduction delay amount representing a time period required for actual start of reproduction of the second content information supplied to the second reproducer is specified according to a second base delay amount corresponding to a reproduction condition of the second content information and a second additional delay amount set in the second delay processor.

In adjustment of the first reproduction delay amount and the second reproduction delay amount, the first delay amount specification module obtains the first base delay amount and the first additional delay amount and gives an instruction to the second delay amount specification module to notify the second base delay amount and the second additional delay amount. The second delay amount specification module receives the instruction for notification and sends back a response of the second base delay amount and the second additional delay amount to the first delay amount specification module. The first delay amount specification module receives the response, extracts the second base delay amount and the second additional delay amount from the received response, and updates the first additional delay amount and the second additional delay amount to make the second reproduction delay amount specified according to the second base delay amount and the second additional delay amount consistent with the first reproduction delay amount specified according to the first base delay amount and the first additional delay amount. The first delay amount specification module sets the updated first additional delay amount in the first delay processor, while giving an instruction to the second delay amount specification module to set the updated second additional delay amount in the second delay processor. The second delay amount specification module receives the instruction and sets the updated second additional delay amount included in the received instruction in the second delay processor.

The content reproduction system according to this aspect of the invention adjusts the first additional delay amount and the second additional delay amount to make the first reproduction delay amount for the first reproducer consistent with the second reproduction delay amount for the second reproducer. This arrangement effectively reduces a potential synchronization error in reproduction of the first content information and the second content information caused by a difference between a reproduction delay of the first content information in the first reproducer and a reproduction delay of the second content information in the second reproducer.

In one preferable application of the content reproduction system according to the above aspect of the invention, the first reproducer and the second reproducer respectively have different communication modules for transmission of the instruction for notification, the response to the instruction for notification, and the instruction for setting, in addition to a first content information communication module for transmission of the first content information in the first reproducer and a second content information communication module for transmission of the second content information in the second reproducer.

This application desirably facilitates transmission of the instruction for notifying the second base delay amount and the second additional delay amount, the response to the instruction for notification, and the instruction for setting the updated second additional delay amount between the first reproducer and the second reproducer.

A protocol SOAP may be adopted for communication by the respective different communication modules in the first reproducer and the second reproducer.

In another preferable application of the content reproduction system according to the above aspect of the invention, the first reproducer further has an adjustment delay amount input module that receives a user's input of an adjustment delay amount. In the user's manual adjustment of the first reproduction delay amount and the second reproduction delay amount, the first delay amount specification module updates the first additional delay amount and the second additional delay amount based on the adjustment delay amount notified by the adjustment delay amount input module. The first delay amount specification module sets the updated first additional delay amount in the first delay processor, while giving an instruction to the second delay amount specification module to set the updated second additional delay amount in the second delay processor. The second delay amount specification module receives the instruction and sets the updated second additional delay amount included in the received instruction in the second delay processor.

The content reproduction system of this application enables adjustment of the first additional delay amount and the second additional delay amount according to the user's input adjustment delay amount.

The invention is not restricted to the content reproduction system described above, but the technique of the invention may also be actualized by diversity of other applications, for example, a corresponding content reproduction method and a first reproducer and a second reproducer used in the content reproduction system. Other possible applications of the invention include a computer program for actualizing the content reproduction system or the content reproduction method, a recording medium in which such a computer program is recorded, and a data signal that includes such a computer program and is embodied in a carrier wave.

In the applications of the invention as the computer program and the recording medium in which the computer program is recorded, the invention may be given as a whole program to control the operations of the content reproduction system or as a partial program to exert only the characteristic functions of the invention. Available examples of the recording medium include flexible disks, CD-ROMs, DVD-ROMs and DVD-RAMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 is a functional block diagram showing the configuration of a content reproduction system in one embodiment of the invention;

FIG. 2 is a flowchart showing an auto adjustment process of a video delay amount and an audio delay amount executed by a delay amount specification module of an image reproducer included in the content reproduction system of FIG. 1;

FIG. 3 (A) through (C) show examples of adjusting the video delay amount and the audio delay amount;

FIG. 4 is a flowchart showing an audio delay amount specification process executed by a delay amount specification module of a sound reproducer included in the content reproduction system of FIG. 1;

FIG. 5 is a flowchart showing a user's manual adjustment process of the video delay amount and the audio delay amount executed by the delay amount specification module of the image reproducer; and

FIG. 6 shows an arrangement of buttons for the user's adjustment of the video delay amount and the audio delay amount on a remote control as the user's operable input unit.

### DESCRIPTION OF THE PREFERRED EMBODIMENTS

Some modes of carrying out the invention are described below in the following sequence with reference to the accompanied drawings:

### A. Embodiment

A1. Configuration of Content Reproduction System

A2. Auto Adjustment Process of Video Delay Amount and Audio Delay Amount

A3. User's Manual Adjustment Process of Video Delay Amount and Audio Delay Amount

A4. Effects

### B. Modifications

### A. Embodiment

### A1. Configuration of Content Reproduction System

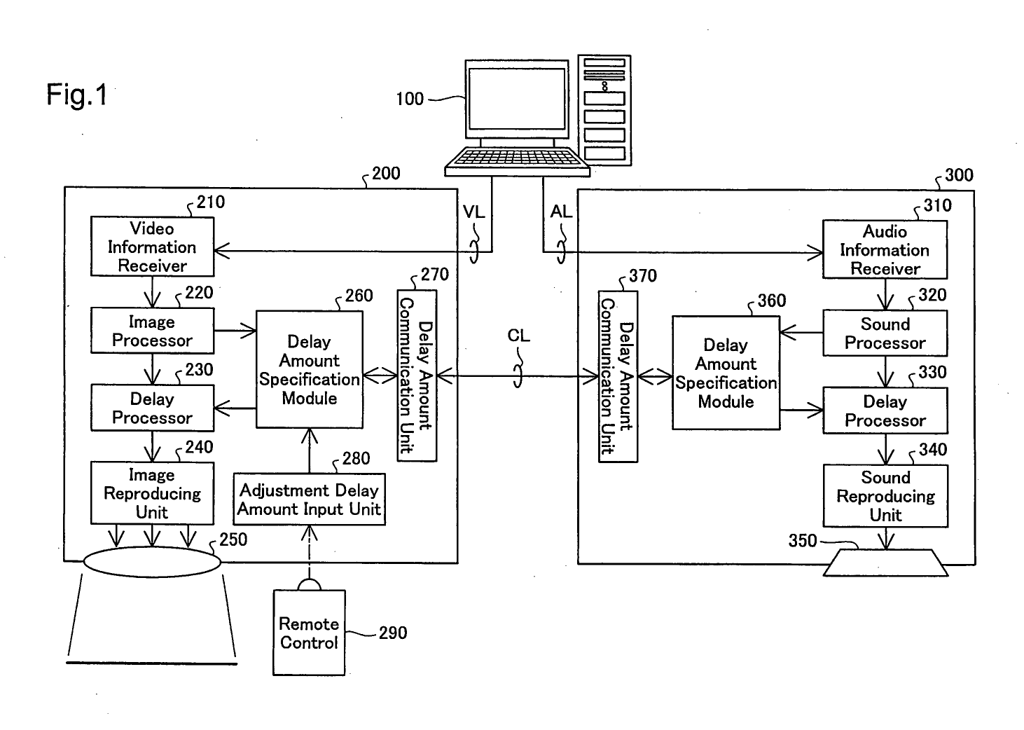

FIG. 1 is a functional block diagram showing the configuration of a content reproduction system 10 in one embodiment of the invention. The content reproduction system 10 includes a content supplier 100 that supplies video information and audio information, which constitute one content to be reproduced, respectively to an image reproducer 200 and to a sound reproducer 300, the image reproducer 200 that reproduces the supplied video information, and the sound reproducer 300 that reproduces the supplied audio information.

The content supplier 100 and the image reproducer 200 are interconnected via a communication path VL (video information communication path) for transmission of video information. The content supplier 100 and the sound reproducer 300 are interconnected via a communication path AL (audio information communication path) for transmission of audio information. The image reproducer 200 and the sound reproducer 300 are interconnected via a communication path CL (delay information communication path) for transmission of information on delay amounts (described later). The signal form of the video information transmitted via the video information communication path VL may be an analog video signal or a digital video signal. Similarly the signal form of the audio information transmitted via the audio information communication path AL may be an analog audio signal or a digital audio signal. The information on delay amounts is transmitted via the delay information communication path CL by TCP/IP-based packet communication.

The image reproducer 200 may be constructed by any of various image display devices, for example, a projector of projecting images or a direct-view liquid crystal display. In the content reproduction system 10 of this embodiment, a projector is adopted for the image reproducer 200.

The sound reproducer 300 is constructed by a speaker system connectable with a network line.

In the image reproducer 200, a video information receiver 210 receives video information as an image source of content information supplied from the content supplier 100. An image processor 220 makes the received video information subjected to diverse series of image processing including high image quality processing. A delay processor 230 delays the processed video information and sends the delayed video information to an image reproducing unit 240. The image reproducing unit 240 reproduces the received delayed video information. A projection unit 250 projects and displays the reproduced video information. In the image reproducer 200, there is a time lag between the supply of the video information and the start of reproduction of the video information. This time lag may be hereafter referred to as ‘video delay amount’.

A delay amount specification module 260 specifies a delay amount, which is used in the delay process performed by the delay processor 230. This delay amount may be hereafter referred to ‘additional video delay amount’. The specification of the additional video delay amount is based on information on a base video delay amount corresponding to an image processing condition adopted in the image processing performed by the image processor 220, information on an audio delay amount sent from the sound reproducer 300 via a delay amount communication unit 270, and information on the user's input adjustment delay amount sent from a remote control 290 via an adjustment delay amount input unit 280. The specified delay amount is set in the delay processor 230. The procedure of specifying the additional video delay amount will be described later in detail.

In the sound reproducer 300, an audio information receiver 310 receives audio information as a sound source of the content information supplied from the content supplier 100. A sound processor 320 makes the received audio information subjected to diverse series of sound processing including high sound quality processing. A delay processor 330 delays the processed audio information and sends the delayed audio information to a sound reproducing unit 340. The sound reproducing unit 340 reproduces the received delayed audio information, which is output from a speaker 350. In the sound reproducer 300, there is a time lag between the supply of the audio information and the start of reproduction of the audio information. This time lag may be hereafter referred to as ‘audio delay amount’.

A delay amount specification module 360 specifies a delay amount, which is used in the delay process performed by the delay processor 330. This delay amount may be hereafter referred to ‘additional audio delay amount’. The specification of the additional audio delay amount is based on information on a base audio delay amount corresponding to a sound processing condition adopted in the sound processing performed by the sound processor 320 and information on the additional video delay amount sent from the image reproducer 200 via a delay amount communication unit 370. The specified delay amount is set in the delay processor 330. The procedure of specifying the additional audio delay amount will be described later in detail.

The content reproduction system 10 of the embodiment adjusts the additional video delay amount set by the delay amount specification module 260 of the image reproducer 200 and the additional audio delay amount set by the delay amount specification module 360 of the sound reproducer 300 according to a procedure described later. The video delay amount required for reproduction of the video information in the image reproducer 200 and the audio delay amount required for reproduction of the audio information in the sound reproducer 300 are then adjusted and set. The video information supplied from the content supplier 100 to the image reproducer 200 and the audio information supplied from the content supplier 100 to the sound reproducer 300 are thus reproducible at a synchronized timing.

### A2. Auto Adjustment Process of Video Delay Amount and Audio Delay Amount

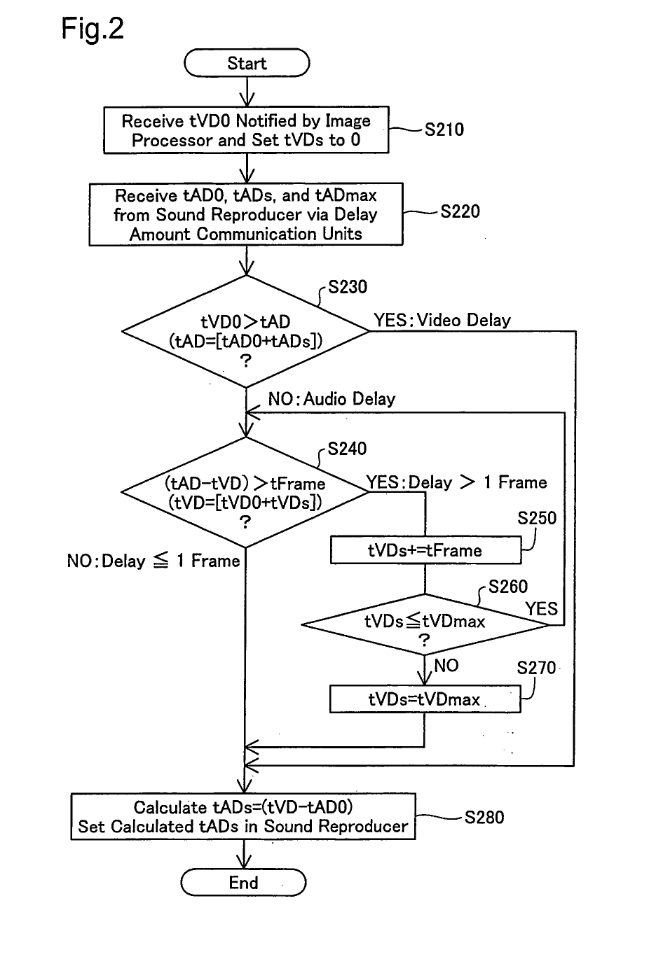

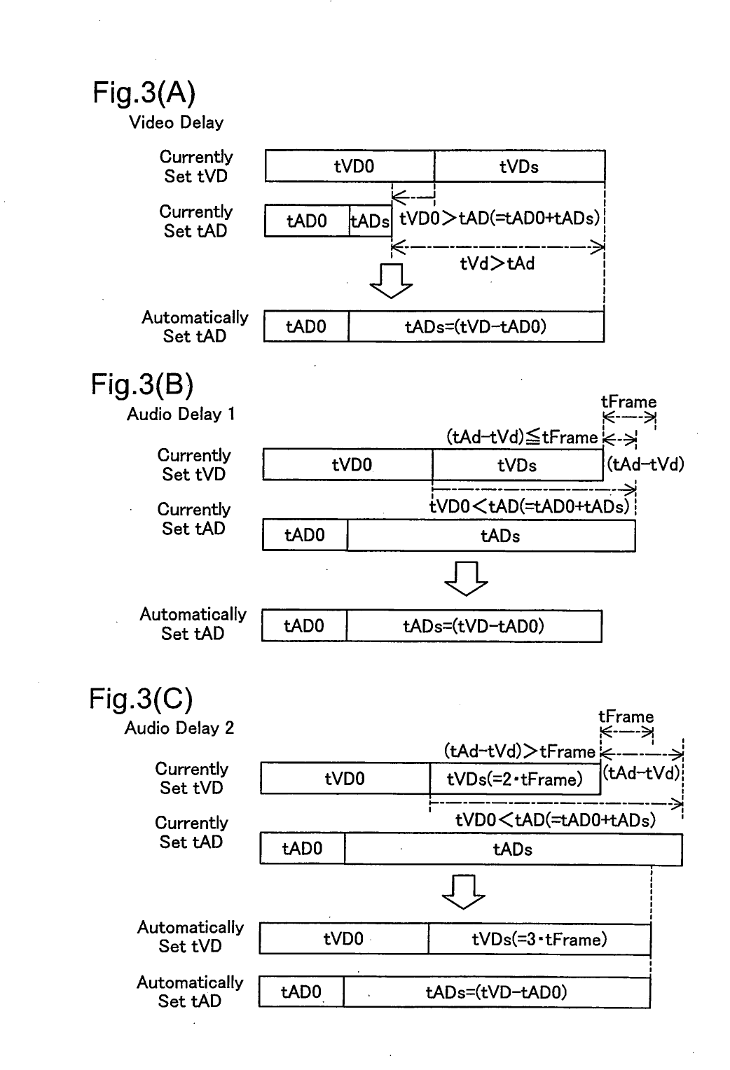

FIG. 2 is a flowchart showing an auto adjustment process of the video delay amount and the audio delay amount executed by the delay amount specification module 260 of the image reproducer 200. FIG. 3 shows examples of adjusting the video delay amount and the audio delay amount.

The delay amount specification module 260 starts the auto adjustment process shown in FIG. 2, in response to notification of a base video delay amount tVD0 from the image processor 220.

The image processor 220 has a table storing values of the base video delay amount corresponding to various image processing conditions performed for the input video information. The image processor 220 refers to this table and dynamically determines the base video delay amount tVD0 according to a selected image processing condition to be performed for the input video information.

On the start of the auto adjustment process, the delay amount specification module 260 first receives the base video delay amount tVD0 notified by the image processor 220 and sets an additional video delay amount tVDs to ‘0’ in the delay processor 230 (step S210).

The delay amount specification module 260 subsequently gives an instruction for notification of information on an audio delay amount tAD in the sound reproducer 300 to the delay amount specification module 360 of the sound reproducer 300 via the delay amount communication unit 270 of the image reproducer 200 and the delay amount communication unit 370 of the sound reproducer 300. The information on the audio delay amount tAD includes a base audio delay amount tAD0, an additional audio delay amount tADs, and a maximum possible additional audio delay amount tADmax. The delay amount specification module 260 receives the information on the audio delay amount tAD notified by the delay amount specification module 360 of the sound reproducer 300 (step S220).

The TCP-IP-based packet communication is adopted for the communication protocol between the delay amount communication unit 270 of the image reproducer 200 and the delay amount communication unit 370 of the sound reproducer 300. A concrete procedure of giving the instruction for notification of the base audio delay amount tAD0, the additional audio delay amount tADs, and the maximum possible additional audio delay amount tADmax newly defines and uses a message command for ‘notification of the current settings of the delay amount’ by an XML- and HTTP-based protocol SOAP (simple object access protocol).

The series of processing executed by the delay amount specification module 360 in the sound reproducer 300 will be described later.

The delay amount specification module 260 then compares the received base video delay amount tVD0 with the computed audio delay amount tAD (=tAD0+tADs) and identifies either a video delay or an audio delay (step S230). The additional audio delay amount tADs is set to ‘0’ in the initial stage as explained later. At the beginning of the processing, this comparison is thus substantially equal to comparison between tVD0 and tAD0.

When tVD0>tAD (=tAD0+tADs) (step S230: yes), for example, in the case of FIG. 3(A), the delay amount specification module 260 identifies the video delay and immediately goes to step S280.

At step S280, the additional audio delay amount tADs (=tVD−tAD0) is calculated by subtracting the base audio delay amount tAD0 from a video delay amount tVD as summation of a current additional video delay amount tVDs and the base video delay amount tVD0. The delay amount specification module 260 then gives an instruction for setting the newly calculated additional audio delay amount tADs to the delay amount specification module 360 of the sound reproducer 300 via the delay amount communication unit 270 of the image reproducer 200 and the delay amount communication unit 370 of the sound reproducer 300. The series of auto adjustment process is here completed. The delay amount specification module 360 of the sound reproducer 300 receives the notified additional audio delay amount tADs and sets the received additional audio delay amount tADs in the delay processor 330 as described later in detail. A concrete procedure of notification of the additional audio delay amount tADs newly defines and uses a message command for ‘setting the additional delay amount’, like the message command for ‘notification of the current settings of the delay amount’.

This series of processing sets the audio delay amount tAD to be consistent with the currently set video delay amount tVD as shown in FIG. 3(A).

When tVD0≦tAD (step S230: no), for example, in the case of FIG. 3(B) or FIG. 3(C), on the other hand, the delay amount specification module 260 identifies the audio delay and executes step S240 alone or steps S240 to S270 prior to processing of step S280.

Upon identification of the audio delay (step S230: no), the delay amount specification module 260 determines whether the audio delay or a difference between the audio delay amount tAD and the video delay amount tVD (=tVD0+tVDs), is greater than a 1-frame time tFrame (step S240).

The video signal representing the video information is processed in the unit of an image signal representing one image plane. This unit is called the frame or field. It is accordingly desirable to vary the delay amount in the unit of a time required for output of a 1-frame image signal from the image processor 220. This time required for the output corresponds to the 1-frame time tFrame. The delay amount set in the delay processor 230 is thus varied in the unit of the 1-frame time tFrame.

As in the illustrated state of FIG. 3(B), when it is determined that the audio delay is not greater than the 1-frame time tFrame, that is, (tAD−tVD)≦tFrame (step S240: no), the delay amount specification module 260 immediately goes to step S280. This series of processing sets the audio delay amount tAD to be consistent with the currently set video delay amount tVD as shown in FIG. 3(B).

As in the illustrated state of FIG. 3(C), when it is determined that the audio delay is greater than the 1-frame time tFrame, that is, (tAD−tVD)>tFrame (step S240: yes), on the other hand, the range of the audio delay amount is extendable by increasing the video delay amount. In this case, the additional video delay amount tVDs is updated by addition of the 1-frame time tFrame to the current additional video delay amount tVDs (tVDs+=tFrame) (step S250). It is then determined whether the updated additional video delay amount tVDs is not greater than a maximum possible additional video delay amount tVDmax, that is, tVDs≦tVDmax (step S260).

When the updated additional video delay amount tVDs is not greater than the maximum possible additional video delay amount tVDmax, that is, tVDs≦tVDmax (step S260: yes), it is possible to set the updated additional video delay amount tVDs in the delay processor 230. The processing flow then goes back to step S240. When it is determined here that the audio delay is not greater than the 1-frame time Tframe (step S240: no), the processing flow goes to step S280. This series of processing sets the audio delay amount tAD to be consistent with the currently set video delay amount tVD as shown in FIG. 3(C).

When the updated additional video delay amount tVDs is greater than the maximum possible additional video delay amount tVDmax, that is, tVDs>tVDmax (step S260: no), it is impossible to set the updated additional video delay amount tVDs in the delay processor 230. The additional video delay amount tVDs is thus restricted to the maximum possible additional video delay amount tVDmax (tVDs=tVDmax) (step S270). The processing flow then goes to step S280. This series of processing sets the audio delay amount tAD to be consistent with the currently set video delay amount tVD.

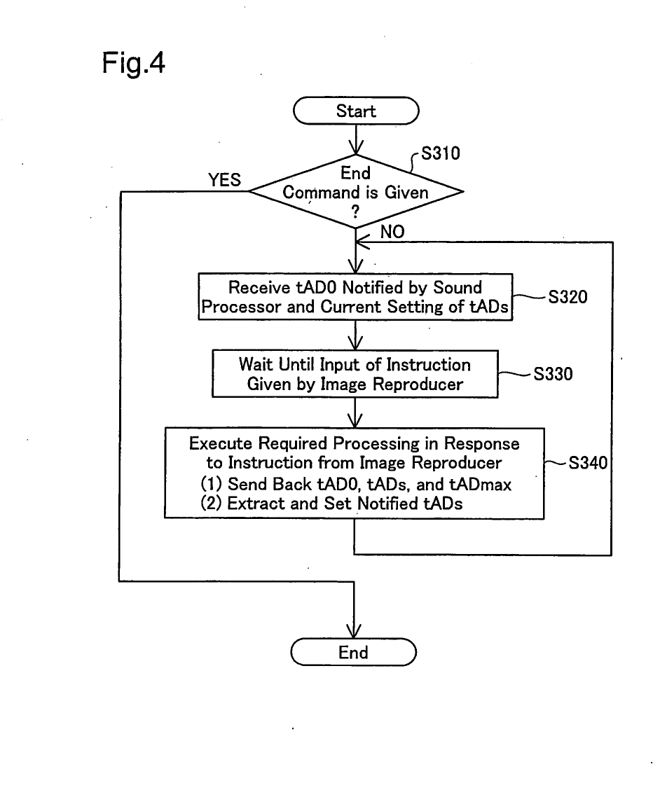

FIG. 4 is a flowchart showing an audio delay amount specification process executed by the delay amount specification module 360 of the sound reproducer 300.

The delay amount specification module 360 starts the audio delay amount specification process of FIG. 4, in response to an instruction given by a controller (not shown). The processing of steps S320 to S340 is repeated until input of an end command (step S310: no).

The delay amount specification module 360 receives the base audio delay amount tAD0 notified by the sound processor 320 and the additional audio delay amount tADs currently set in the delay processor 330 (step S320).

As in the image processor 220 of the image reproducer 200, the sound reproducer 320 refers to a table storing values of the base audio delay amount corresponding to various sound processing conditions performed for the input audio information and dynamically determines the base audio delay amount tAD0 according to a selected sound processing condition to be performed for the input audio information.

At step S330, the delay amount specification module 360 waits until input of the instruction given by the delay amount specification module 260 of the image reproducer 200 via the delay amount communication unit 270 of the image reproducer 200 and the delay amount communication unit 370 of the sound reproducer 300.

At step S340, the delay amount specification module 360 performs a required series of processing in response to the input instruction given by the delay amount specification module 260 of the image reproducer 200. When receiving the instruction for ‘notification of the current settings of the delay amount’ (see step S220 in FIG. 2), the delay amount specification module 360 sends back the base audio delay amount tAD0, the additional audio delay amount tADs, and the maximum possible additional audio delay amount tADmax to the delay amount specification module 260 of the image reproducer 200. When receiving the instruction for ‘setting the additional delay amount’ (see step S280 in FIG. 2), the delay amount specification module 360 extracts the notified additional audio delay amount tADs included in the instruction and sets the additional audio delay amount tADs in the delay processor 330. The delay processor 330 is then operated with the audio delay amount tAD including the newly set additional audio delay amount tADs.

As described above, the delay amount specification module 260 of the image reproducer 200 specifies the video delay amount and the audio delay amount according to the auto adjustment process shown in the flowchart of FIG. 2, while the delay amount specification module 360 of the sound reproducer 300 sets the audio delay amount according to the specification process shown in the flowchart of FIG. 4.

It is preferable to provide a sufficient range of the expected delay amount settable in the delay processor 230 of the image reproducer 200 and in the delay processor 330 of the sound reproducer 300. Delay amounts determined as described below may be set to maximum allowable additional delay amounts in the respective delay processors 230 and 330.

According to the broadcast standard in Japan, the maximum allowable delay of the audio signal to the video signal is 185 ms. In the course of IP conversion and other series of processing for the higher image quality, there is at least a delay of 1-frame time (approximately 33 ms) in the interlace signal. A maximum allowable additional video delay amount set by the delay amount specification module 260 of the image reproducer 200 is thus ideally required to be 152 ms (=[185−33] ms). This is equivalent to a delay amount of 5·tFrame, where tFrame denotes the 1-frame time. In practice, however, a delay amount of 3·tFrame is sufficient for the maximum allowable additional video delay amount.

The advance of the audio signal relative to the video signal is expected to the 90 ms at the maximum. A maximum allowable additional audio delay amount set by the delay amount specification module 360 of the sound reproducer 300 is thus contemplated to be about 123 ms (=[90+33] ms).

### A3. User's Manual Adjustment Process of Video Delay Amount and Audio Delay Amount

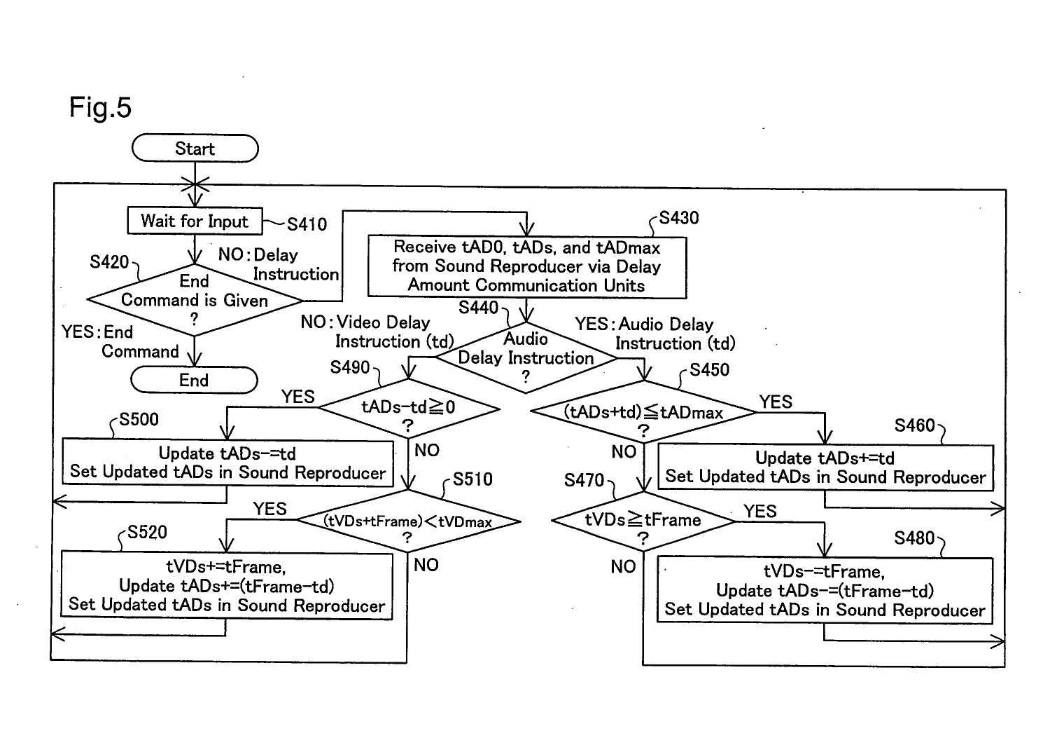

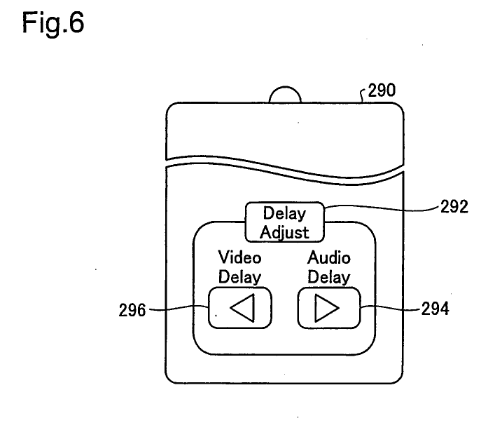

FIG. 5 is a flowchart showing the user's manual adjustment process of the video delay amount and the audio delay amount executed by the delay amount specification module 260 of the image reproducer 200. FIG. 6 shows an arrangement of buttons for the user's adjustment of the video delay amount and the audio delay amount on the remote control 290 as the user's operable input unit.

When the user presses down a ‘Delay Adjust’ button 292 on the remote control 290, the adjustment delay amount input unit 280 gives a start command for the manual adjustment of the video delay amount and the audio delay amount. In response to this start command, the delay amount specification module 260 of the image reproducer 200 starts the manual adjustment process shown in the flowchart of FIG. 5.

The delay amount specification module 260 waits until input of the user's instruction from the adjustment delay amount input unit 280 in response to the user's button operation on the remote control 290 (step S410).

The delay amount specification module 260 identifies whether the input instruction is an end command (step S420). The end command is given by the user's double press of the ‘Delay Adjust’ button 292. This is, however, not restrictive, but a separate End button may be provided.

When the input instruction is the end command (step S420: yes), the processing flow is immediately terminated. When the input instruction is other than the end command (step S420: no), on the other hand, the input instruction is expected to be either an audio delay instruction or a video delay instruction. In this case, the processing flow executes either the processing of steps S450 to S480 or the processing of steps S490 to S520 after steps S430 and S440.

At step S430, the delay amount specification module 260 gives an instruction for notification of the information on the audio delay amount tAD in the sound reproducer 300 to the delay amount specification module 360 of the sound reproducer 300 via the delay amount communication unit 270 of the image reproducer 200 and the delay amount communication unit 370 of the sound reproducer 300, and receives the information on the audio delay amount tAD notified by the delay amount specification module 360 of the sound reproducer 300. The information on the audio delay amount tAD includes the base audio delay amount tAD0, the additional audio delay amount tADs, and the maximum possible additional audio delay amount tADmax. The information notified here is identical with the information notified at step S220 in the auto adjustment process of FIG. 2. The processing of step S430 may thus be omitted when not required.

At step S440, the delay amount specification module 260 identifies whether the input instruction is an audio delay instruction by the user's press of an ‘Audio Delay’ button 294 on the remote control 290 or a video delay instruction by the user's press of a ‘Video Delay’ button 296 on the remote control 290.

Upon identification of the audio delay instruction (step S440: yes), the delay amount specification module 260 executes the processing of steps S450 to S480 and goes back to step S410. Upon identification of the video delay instruction (step S440: no), on the other hand, the delay amount specification module 260 executes the processing of steps S490 to S520 and goes back to step S410. Namely the processing of steps S410 to S520 is repeated until input of the end command.

An adjustment delay amount ‘td’ is used for each audio delay instruction or each video delay instruction. The adjustment delay amount ‘td’ is preferably smaller than the 1-frame time tFrame. For example, when the 1-frame time tFrame=33 ms, the adjustment delay amount td=5 ms.

The following describes the processing of steps S450 to S480 executed in response to the audio delay instruction.

At step S450, the delay amount specification module 260 determines whether the sum of the additional audio delay amount tADs and the adjustment delay amount ‘td’ is not greater than the maximum possible additional audio delay amount tADmax ([tADs+td]≦tADmax). This determines the allowance for the delay by the adjustment delay amount ‘td’.

When [tADs+td]≦tADmax (step S450: yes), the delay by the adjustment delay amount ‘td’ is enabled. In this case, the processing flow executes step S460 and goes back to step S410.

At step S460, the additional audio delay amount tADs is updated by adding the adjustment delay amount ‘td’ to the current additional audio delay amount tADs (tADS+=td). The delay amount specification module 260 then gives an instruction for setting the updated additional audio delay amount tADs to the delay amount specification module 360 of the sound reproducer 300 via the delay amount communication unit 270 of the image reproducer 200 and the delay amount communication unit 370 of the sound reproducer 300.

When [tADs+td]>tADmax (step S450: no), on the other hand, the delay amount specification module 260 subsequently determines whether the additional video delay amount tVDs is not less than the 1-frame time tFrame (tVDs≧tFrame) (step S470).

When tVDs≧tFrame (step S470: yes), the processing flow executes step S480 and goes back to step S410. When tVDs<tFrame (step S470: no), on the other hand, the processing flow immediately goes back to step S410.

At step S480, the additional video delay amount tVDs is updated by subtracting the 1-frame time tFrame from the current additional video delay amount tVDs (tVDs−=tFrame). The additional audio delay amount tADs is also updated by subtracting the result of subtraction of the adjustment delay amount ‘td’ from the 1-frame time tFrame from the current additional audio delay amount tADs (tADs−=[tFrame−td]). The delay amount specification module 260 then gives an instruction for setting the updated additional audio delay amount tADs to the delay amount specification module 360 of the sound reproducer 300 via the delay amount communication unit 270 of the image reproducer 200 and the delay amount communication unit 370 of the sound reproducer 300.

This series of processing completes adjustment of the delay corresponding to the adjustment delay mount ‘td’ in response to the audio delay instruction.

The following describes the processing of steps S490 to S520 executed in response to the video delay instruction.

At step S490, the delay amount specification module 260 determines whether the result of subtraction of the adjustment delay amount ‘td’ from the additional audio delay amount tADs is not less than ‘0’ ([tADs−td]≧0).

When [tADs−td]≧0 (step S490: yes), the processing flow executes step S500 and goes back to step S410.

At step S500, the additional audio delay amount tADs is updated by subtracting the adjustment delay amount ‘td’ from the current additional audio delay amount tADs (tADS−=td). The delay amount specification module 260 then gives an instruction for setting the updated additional audio delay amount tADs to the delay amount specification module 360 of the sound reproducer 300 via the delay amount communication unit 270 of the image reproducer 200 and the delay amount communication unit 370 of the sound reproducer 300.

When [tADs−td]<0 (step S490: no), on the other hand, the delay amount specification module 260 subsequently determines whether the sum of the additional video delay amount tVDs and the 1-frame time tFrame is less than the maximum possible additional video delay amount tVDmax ([tVDs+tFrame]<tVDmax) (step S510).

When [tVDs+tFrame]<tVDmax (step S510: yes), the processing flow executes step S520 and goes back to step S410. When [tVDs+tFrame]≧tVDmax (step S510: no), on the other hand, the processing flow immediately goes back to step S410.

At step S520, the additional video delay amount tVDs is updated by adding the 1-frame time tFrame to the current additional video delay amount tVDs (tVDs+=tFrame). The additional audio delay amount tADs is also updated by adding the result of subtraction of the adjustment delay amount ‘td’ from the 1-frame time tFrame to the current additional audio delay amount tADs (tADs+=[tFrame−td]). The delay amount specification module 260 then gives an instruction for setting the updated additional audio delay amount tADs to the delay amount specification module 360 of the sound reproducer 300 via the delay amount communication unit 270 of the image reproducer 200 and the delay amount communication unit 370 of the sound reproducer 300.

This series of processing completes adjustment of the delay corresponding to the adjustment delay mount ‘td’ in response to the video delay instruction.

The operations of the delay amount specification module 360 of the sound reproducer 300 in the user's manual adjustment process of the video delay amount and the audio delay amount are identical with the series of processing shown in FIG. 4 and are thus not specifically described here.

As described above, the delay amount specification module 260 of the image reproducer 200 executes the user's manual adjustment process of the video delay amount and the audio delay amount shown in the flowchart of FIG. 5 to attain adjustment of the user's desired delay amount.

### A4. Effects

In the content reproduction system 10 of the embodiment described above, the delay amount specification module 260 of the image reproducer 200 executes the auto adjustment process of the video delay amount and the audio delay amount shown in the flowchart of FIG. 2, while the delay amount specification module 360 of the sound reproducer 300 executes the audio delay amount specification process shown in the flowchart of FIG. 4. These settings effectively reduce a potential difference in reproduction timing (potential synchronization error) caused by a difference between a reproduction delay in the image reproducer 200 and a reproduction delay in the sound reproducer 300. This arrangement thus readily attains the better content viewing and listening environment at the synchronized timing.

In the content reproduction system 10 of the embodiment, in response to the user's input instruction through the user's manual operation of the remote control 290, the delay amount specification module 260 of the image reproducer 200 executes the user's manual adjustment process of the video delay amount and the audio delay amount. The user's manual adjustment effectively reduces a difference between a transmission delay of video information supplied from the content supplier 100 to the image reproducer 200 and a transmission delay of audio information supplied from the content supplier 100 to the sound reproducer 300 (transmission delay difference), as well as a difference between a transmission timing of the video information and a transmission timing of the audio information in the content supplier 100 (transmission timing difference).

The content reproduction system 10 of the embodiment adjusts both the video delay amount and the audio delay amount. This ensures the wider adjustment range, compared with the conventional system of adjusting only the audio delay amount.

In the content reproduction system 10 of the embodiment, the image reproducer 200 enables the comprehensive adjustment of the delay amounts corresponding to the advance and the delay of the reproduction timing in the image reproducer 200 and the reproduction timing in the sound reproducer 300. This arrangement ensures the easier adjustment, compared with independent adjustment of the delay amounts in the respective reproducers.

### B. Modifications

The embodiment discussed above is to be considered in all aspects as illustrative and not restrictive. There may be many modifications, changes, and alterations without departing from the scope or spirit of the main characteristics of the present invention.

### B1. Modified Example 1

In the content reproduction system 10 of the embodiment, the delay amount specification module 260 of the image reproducer 200 specifies and adjusts the additional video delay amount tVDs and the additional audio delay amount tADs to make the video delay amount tVD consistent with the audio delay amount tAD. The specified or adjusted additional audio delay amount tADs is set in the delay amount specification module 360 of the sound reproducer 300. This procedure is, however, not restrictive. In one modified application, the delay amount specification module 360 of the sound reproducer 300 specifies and adjusts the additional video delay amount tVDs and the additional audio delay amount tADs to make the video delay amount tVD consistent with the audio delay amount tAD. The specified or adjusted additional video delay amount tVDs is set in the delay amount specification module 260 of the image reproducer 200.

### B2. Modified Example 2

The embodiment regards the video information and the audio information as the first content information and the second content information to be reproduced at the synchronized timing. This is, however, not essential, but the first content information and the second content information may be both video information or may be both audio information. The technique of the invention is applicable to reproduction of first content information and second content information, which constitute one content and are to be played back at a synchronized timing, respectively by a first reproducer and a second reproducer.

### B3. Modified Example 3

In the content reproduction system 10 of the embodiment, the video information communication path VL, the audio information communication path AL, and the delay information communication path CL are provided as independent pathways. This configuration is, however, not essential. One common communication pathway may be used as both the video information communication path and the audio information communication path. One common communication pathway may be used as all the video information communication path, the audio information communication path, and the delay information communication path. In application of the common communication pathway, the video information and the audio information are transmitted by RTP (real-time transport protocol)-based multicast communication.

### B4. Modified Example 4

In the content reproduction system 10 of the embodiment, the communication protocol SOAP is adopted for communication between the image reproducer 200 and the sound reproducer 300. This is, however, not essential, but any of various communication protocols that enable definition of message commands for ‘notification of the current settings of the delay amount’ and ‘setting the additional delay amount’, for example, HTTP or XML, may be adopted for the same purpose.

What is claimed is:

1. A content reproduction system that uses a first reproducer and a second reproducer to respectively reproduce corresponding first content information and second content information, which are to be played back at a synchronized timing,
the first reproducer comprising:
a first delay processor that delays a reproduction timing of the first content information supplied to the first reproducer; and
a first delay amount specification module that specifies a delay amount for the first delay processor and sets the specified delay amount in the first delay processor,
the second reproducer comprising:
a second delay processor that delays a reproduction timing of the second content information supplied to the second reproducer; and
a second delay amount specification module that specifies a delay amount for the second delay processor and sets the specified delay amount in the second delay processor,
wherein a first reproduction delay amount representing a time period required for actual start of reproduction of the first content information supplied to the first reproducer is specified according to a first base delay amount corresponding to a reproduction condition of the first content information and a first additional delay amount set in the first delay processor, and
a second reproduction delay amount representing a time period required for actual start of reproduction of the second content information supplied to the second reproducer is specified according to a second base delay amount corresponding to a reproduction condition of the second content information and a second additional delay amount set in the second delay processor,
in adjustment of the first reproduction delay amount and the second reproduction delay amount,
the first delay amount specification module obtaining the first base delay amount and the first additional delay amount and giving an instruction to the second delay amount specification module to notify the second base delay amount and the second additional delay amount,
the second delay amount specification module receiving the instruction for notification and sending back a response of the second base delay amount and the second additional delay amount to the first delay amount specification module,
the first delay amount specification module receiving the response, extracting the second base delay amount and the second additional delay amount from the received response, and updating the first additional delay amount and the second additional delay amount to make the second reproduction delay amount specified according to the second base delay amount and the second additional delay amount consistent with the first reproduction delay amount specified according to the first base delay amount and the first additional delay amount,
the first delay amount specification module setting the updated first additional delay amount in the first delay processor, while giving an instruction to the second delay amount specification module to set the updated second additional delay amount in the second delay processor,
the second delay amount specification module receiving the instruction and setting the updated second additional delay amount included in the received instruction in the second delay processor.

2. The content reproduction system in accordance with claim 1, wherein the first reproducer and the second reproducer respectively comprise different communication modules for transmission of the instruction for notification, the response to the instruction for notification, and the instruction for setting, in addition to a first content information communication module for transmission of the first content information in the first reproducer and a second content information communication module for transmission of the second content information in the second reproducer.

3. The content reproduction system in accordance with claim 2, wherein a protocol SOAP is adopted for communication by the respective different communication modules in the first reproducer and the second reproducer.

4. The content reproduction system in accordance with claim 1, wherein the first reproducer further comprises an adjustment delay amount input module that receives a user's input of an adjustment delay amount,
in the user's manual adjustment of the first reproduction delay amount and the second reproduction delay amount,
the first delay amount specification module updating the first additional delay amount and the second additional delay amount based on the adjustment delay amount notified by the adjustment delay amount input module,
the first delay amount specification module setting the updated first additional delay amount in the first delay processor, while giving an instruction to the second delay amount specification module to set the updated second additional delay amount in the second delay processor,
the second delay amount specification module receiving the instruction and setting the updated second additional delay amount included in the received instruction in the second delay processor.

5. A first reproducer used in a content reproduction system that includes the first reproducer and a second reproducer to respectively reproduce corresponding first content information and second content information, which are to be played back at a synchronized timing,
the first reproducer comprising:
a first delay processor that delays a reproduction timing of the first content information supplied to the first reproducer; and
a first delay amount specification module that specifies a delay amount for the first delay processor and sets the specified delay amount in the first delay processor,
in the content reproduction system, in adjustment of a first reproduction delay amount representing a time period required for actual start of reproduction of the first content information supplied to the first reproducer and a second reproduction delay amount representing a time period required for actual start of reproduction of the second content information supplied to the second reproducer,
the first delay amount specification module obtaining a first base delay amount corresponding to a reproduction condition of the first content information and a first additional delay amount set in the first delay processor, giving an instruction to the second reproducer to notify a second base delay amount corresponding to a reproduction condition of the second content information and a second additional delay amount set in the second reproducer, and receiving the notified second base delay amount and the notified second additional delay amount,
the first delay amount specification module updating the first additional delay amount and the second additional delay amount to make the second reproduction delay amount specified according to the second base delay amount and the second additional delay amount consistent with the first reproduction delay amount specified according to the first base delay amount and the first additional delay amount,
the first delay amount specification module setting the updated first additional delay amount in the first delay processor, while giving an instruction to the second reproducer to set the updated second additional delay amount in the second reproducer.

6. A second reproducer used in a content reproduction system that includes a first reproducer and the second reproducer to respectively reproduce corresponding first content information and second content information, which are to be played back at a synchronized timing,
the second reproducer comprising:
a second delay processor that delays a reproduction timing of the second content information supplied to the second reproducer; and
a second delay amount specification module that specifies a delay amount for the second delay processor and sets the specified delay amount in the second delay processor,
in the content reproduction system, in adjustment of a first reproduction delay amount representing a time period required for actual start of reproduction of the first content information supplied to the first reproducer and a second reproduction delay amount representing a time period required for actual start of reproduction of the second content information supplied to the second reproducer,
the second delay amount specification module receiving an instruction from the first reproducer to notify a second base delay amount corresponding to a reproduction condition of the second content information and a second additional delay amount set in the second delay processor and sending back a response of the second base delay amount and the second additional delay amount to the first reproducer,
the second delay amount specification module receiving an instruction from the first reproducer to set an updated second additional delay amount in the second delay processor and setting the updated second additional delay amount included in the instruction in the second delay processor.

7. A content reproduction method that uses a first reproducer and a second reproducer to respectively reproduce corresponding first content information and second content information, which are to be played back at a synchronized timing,
the content reproduction method comprising the steps of:
(a) specifying a first reproduction delay amount, which represents a time period required for actual start of reproduction of the first content information supplied to the first reproducer, according to a first base delay amount corresponding to a reproduction condition of the first content information and a first additional delay amount set in a first delay processor provided in the first reproducer;
(b) specifying a second reproduction delay amount, which represents a time period required for actual start of reproduction of the second content information supplied to the second reproducer, according to a second base delay amount corresponding to a reproduction condition of the second content information and a second additional delay amount set in a second delay processor provided in the second reproducer; and
(c) adjusting the first reproduction delay amount and the second reproduction delay amount,
the step (c) comprising the steps of:
(c-1) causing the first reproducer to obtain the first base delay amount and the first additional delay amount and to give an instruction to the second reproducer to notify the second base delay amount and the second additional delay amount;
(c-2) causing the second reproducer to receive the instruction for notification and to send back a response of the second base delay amount and the second additional delay amount set in the second delay processor to the first reproducer;
(c-3) causing the first reproducer to receive the response, to extract the second base delay amount and the second additional delay amount from the received response, and to update the first additional delay amount and the second additional delay amount to make the second reproduction delay amount specified according to the second base delay amount and the second additional delay amount consistent with the first reproduction delay amount specified according to the first base delay amount and the first additional delay amount,
further causing the first reproducer to set the updated first additional delay amount in the first delay processor and to give an instruction to the second reproducer to set the updated second additional delay amount in the second delay processor; and
(c-4) causing the second reproducer to receive the instruction and to set the updated second additional delay amount included in the received instruction in the second delay processor.
